(19) United States
(12) Patent Application Publication
(10) Pub. No.: US 2004/0241264 A1
(43) Pub. Date: Dec. 2, 2004

(54) Removable material injection device for rubber injection machine

(76) Inventor: Chin-Yung Peng, Chang-Hua City (TW)

Correspondence Address: CHIN-YUNG PENG, P.O. BOX 487, Chang-Hua City, 500, TW

(21) Appl. No.: 10/445,002

(22) Filed: May 27, 2003

(51) Int. Cl. B29C 45/07

(52) U.S. Cl. 425/190; 425/543

(57) ABSTRACT

A movable material injection device for a rubber injection machine includes two heat two heat isolating boards and a mediate part sandwiched between the two heat isolating boards. The movable material injection device is connected to a pushing device which sends the movable material injection device horizontally to the position between the top set and the mold assembly of the rubber injection machine. Runners are defined in the two heat isolating boards and the mediate part, and communicate with the cavities of the mold assembly and the material feeding device connected to the top set. The movable material injection device is removed from the mold assembly after rubber is injected into the cavities in the mold assembly so that the rubber in the runners of the movable material injection device is not heated with the mold assembly.

### FIELD OF THE INVENTION

The present invention relates to material injection device that is movably positioned between the mold assembly and the top board of the machine so that after the rubber is injected into the mold assembly, the material injection device is removed so that the material remained in the device is not heated.

### BACKGROUND OF THE INVENTION

A conventional rubber injection machine 90 is disclosed in FIG. 6 and generally includes a top set 91 with a material feeding device connected thereto and the material feeding device has a injection nozzle 94. A lower set 92 is supported by a hydraulic device and a mold assembly 93 is supported on the lower set 92 so that the mold assembly 93 is raised to contact the top set 91. The nozzle 94 injects rubber into the cavities 931 defined in the mold assembly 93 and the mold assembly is then heated so that the rubber can be transferred into product in the cavities 931. Nevertheless, the rubber in the runners communicating with the cavities 931 is heated and become scrap and stocked in the runners. The manufacturers have to clean the scrap, out from the runners and discard the scrap.

The present invention intends to provide a movable material injection device that can be removed from a top of the mold assembly after the rubber is injected into the mold assembly so that the rubber in the material injection device is not heated and can be used again.

### SUMMARY OF THE INVENTION

In accordance with one aspect of the present invention, there is provided a movable material injection device for a rubber injection machine. The movable material injection device is connected to a pushing device and can be moved between a position between the top set of the machine and a position being horizontally removed from the machine. The movable material injection assembly includes two heat isolating boards and a mediate part sandwiched between the two heat isolating boards. Runners are defined in the two heat isolating boards and the mediate part. The runners communicate with the cavities of the mold assembly and the material feeding device on the top set.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the material injection device is sent to the rubber injection machine;

FIG. 2 shows the material injection device is removed from the rubber injection machine;

FIG. 3 is a cross sectional view to show the material injection device located between the top set of the rubber injection machine and the mold assembly,

FIG. 4 shows there are two types of sleeve for enclosing the runners;

FIG. 5 shows the positions that the sleeves are located in the mold assembly, and

FIG. 6 is a side view to show the conventional rubber injection machine.

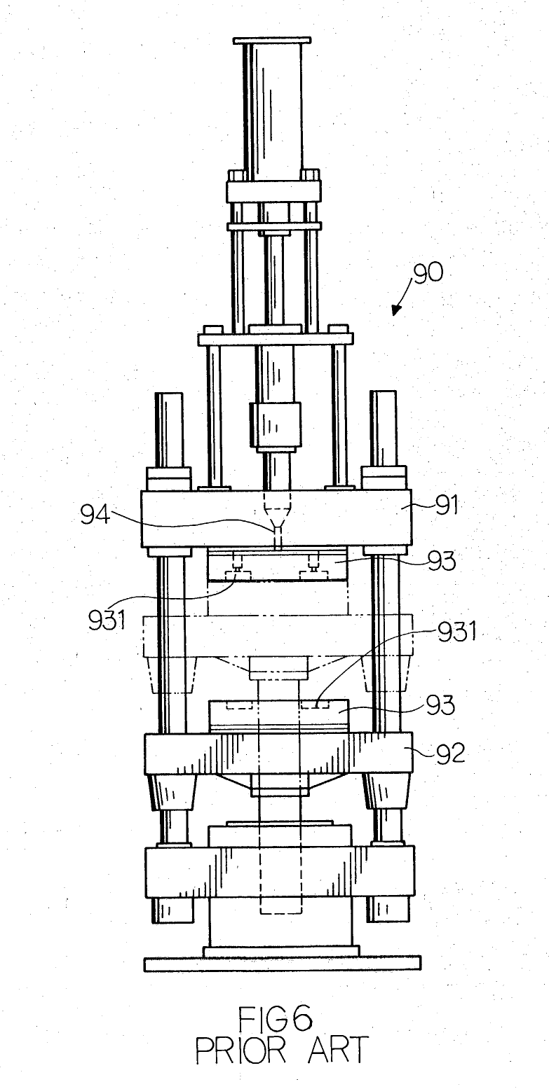

### DETAILED DESCRIPTION OF THE PREFERRED EMBODIMENT

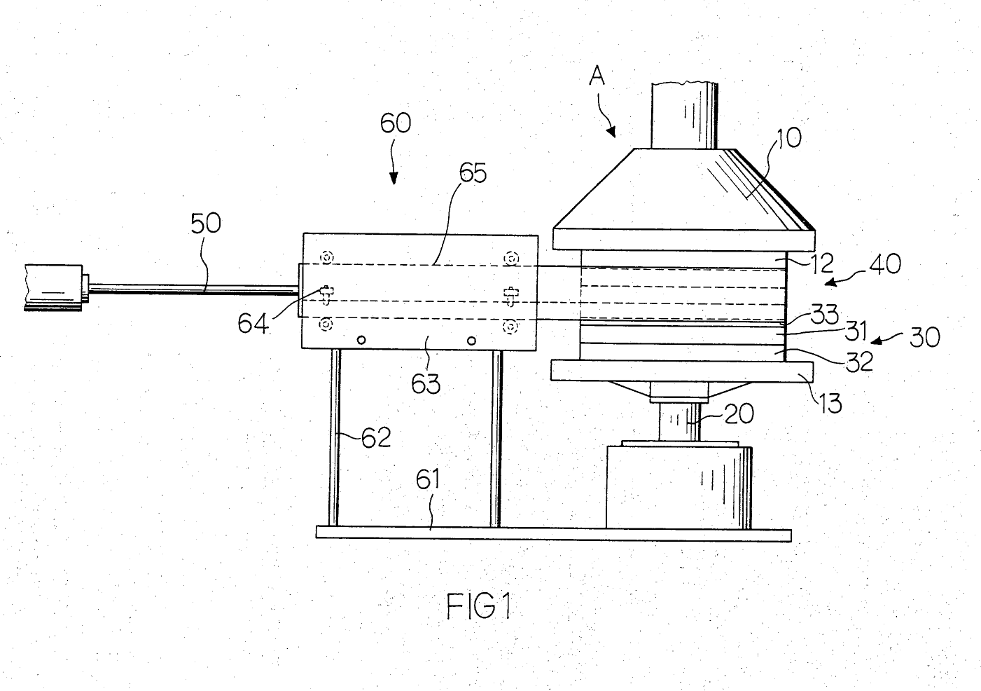

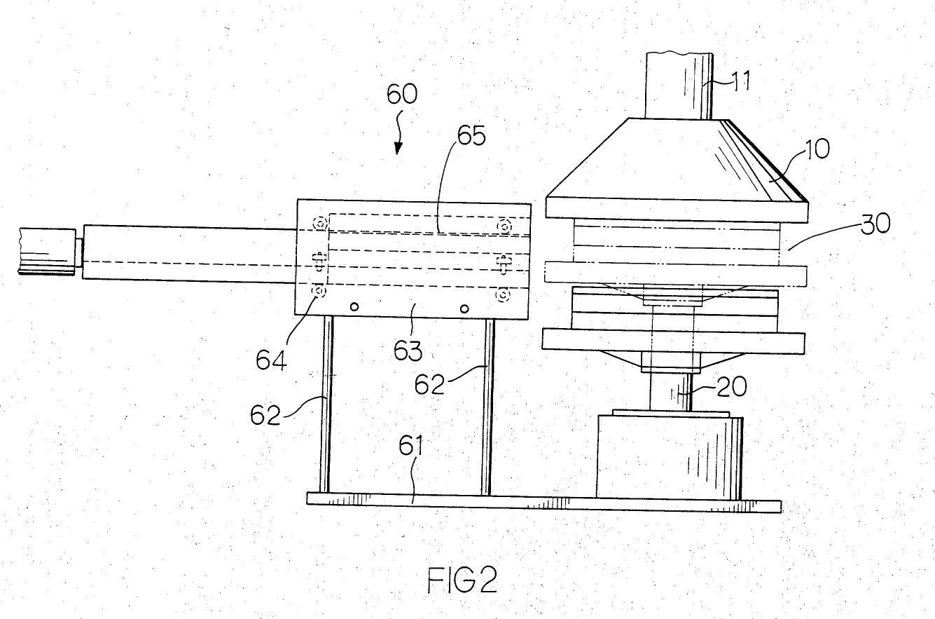

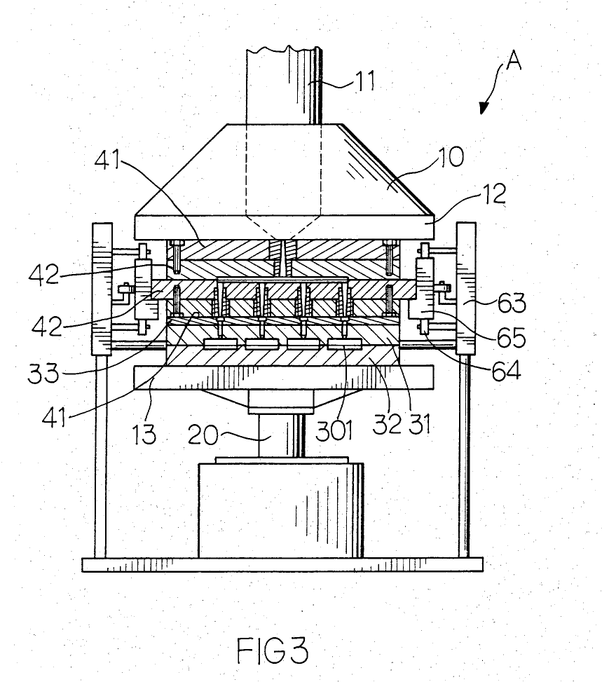

Referring to FIGS. 1 to 3, a rubber injection machine “A” includes a top set 10 with a material feeding device 11 connected to a top thereof and a top board 12 is connected to an underside of the top set 10. A nozzle of the material feeding device 11 communicates with an underside of the top board 12. A lower set 13 is supported on a hydraulic device 20 and a mold assembly 30 is located on the lower set 13. The mold assembly 30 includes a top mold 31 and a lower mold 32 and each of which has cavities 301 defined therein Which are matched to form a desired shape of contour for the products. A scrap removing board 33 is connected to a top of the top mold 31. The mold assembly 30 can be lifted by the hydraulic device 20.

The movable material injection device 60 comprises a frame 63 supported by posts 62 on a pad 61 and the hydraulic device 20 is set on the same pad 61. A passage 65 is defined through the frame 63 and the material injection assembly 40 is movably received in the passage 65 and movable on rollers 64. The material injection assembly 40 is further connected to a pushing device 50 which sends the material injection assembly 40 onto the mold assembly 30.

The injection assembly 40 includes two heat isolating boards 41 and a mediate part composed of two steel boards 42 sandwiched between the two heat isolating boards 41. Runners are defined in the two heat isolating boards 41 and the mediate part 42. The runners communicate with the nozzle of the material feeding device 11, and the cavities 301 of the mold assembly 30.

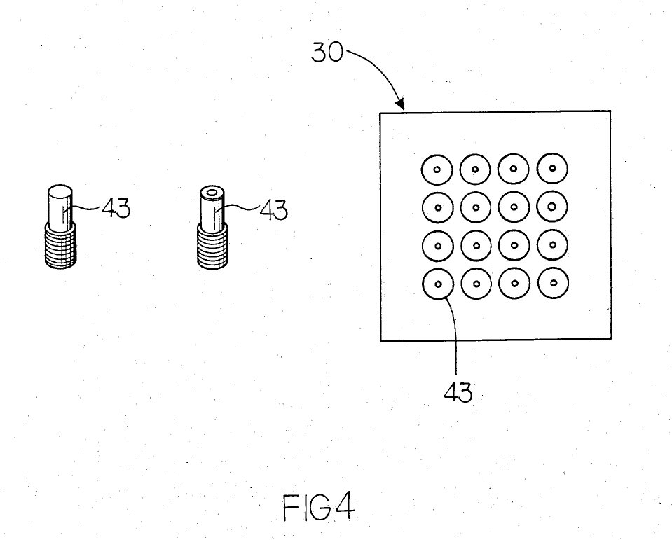

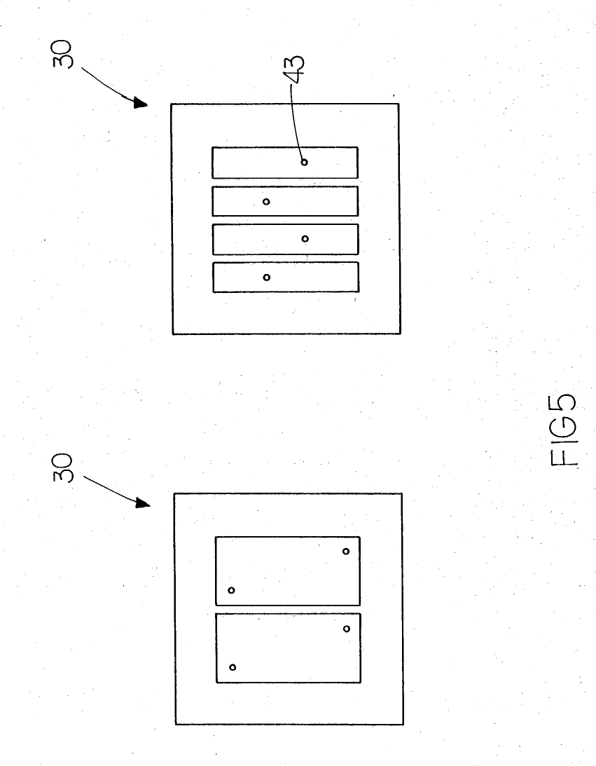

Further referring to FIGS. 4 and 5, each runner is enclosed by a sleeve 43 which may includes an open end and a close end, or two open ends. The close end prevents the material to pass therethrough and the two open-end sleeves 43 allow the material to pass and enter the cavities 301 in the mold assembly 30. Therefore, the same material injection device 40 can be used for different type of mold assembly 30 by arranging the sleeve 43 in proper positions as shown in FIGS. 4 and 5.

The material injection device 40 can be removed from the rubber injection machine “A” after the rubber is injected in the cavities 301 in the mold assembly 30. The mold assembly 30 is then raised to contact the top board 12 and heated. The material injection device 40 and the rubber in the runners in the material injection device 40 is not heated with the mold assembly 30 so that the rubber can be re-used again. This saves a lot of rubber and time.

While we have shown and described the embodiment in accordance with the present invention, it should be clear to those skilled in the art that further embodiments may be made without departing from the scope of the present invention.

What is claimed is:

1. A movable material injection device for a rubber injection machine which includes a top set with a material feeding device connected thereto and a top board connected to an underside of the top set, a lower set supported on a hydraulic device and a mold assembly is located on the lower set, the mold assembly having cavities defined therein, the movable material injection device comprising:
a frame having a passage defined therethrough and a material injection assembly movably received in the passage, the material injection assembly connected to a pushing device so as to send the material injection assembly to be adapted to locate on the mold assembly, the injection assembly including two heat isolating boards and a mediate part being sandwiched between the two heat isolating boards, runners defined in the two heat isolating boards and the mediate part, the runners adapted to communicate with, the cavities of the mold assembly.

2. The movable material injection device as claimed in claim 1 further comprising rollers in the passage and the movable material injection device movable on the rollers.

3. The movable material injection device as claimed in claim 1, wherein a sleeve encloses each runner.

4. The movable material injection device as claimed in claim 3, wherein the sleeve includes an open end and a close end.

5. The movable material injection device as claimed in claim 3, wherein the sleeve includes two open ends.
